(19) United States
(12) Patent Application Publication
(10) Pub. No.: US 2024/0262108 A1
(43) Pub. Date: Aug. 8, 2024

(54) METHOD FOR OPERATING A PRINTING APPARATUS, PRINTING APPARATUS AND SOFTWARE PRODUCT

(71) Applicant: Canon Production Printing Holding B.V., Venlo (NL)

(72) Inventor: Cornelis P.M. VAN HEIJST, Venlo (NL)

(73) Assignee: Canon Production Printing Holding B.V., Venlo (NL)

(21) Appl. No.: 18/418,539

(22) Filed: Jan. 22, 2024

(30) Foreign Application Priority Data
Feb. 3, 2023 (EP) 23154824.9

(51) Int. Cl. B41J 2/45; B41J 2/47

(52) U.S. Cl. CPC B41J 2/451; B41J 2/47

(57) ABSTRACT

In a method for operating a printing apparatus and an printing apparatus suitable for performing such a method, the printing apparatus includes a page-wide curing array including a number of individually controllable units. The individually controllable units are operable in at least two modes, the at least two modes being an Off mode and an On mode.

The present invention relates to a method for operating a printing apparatus and an printing apparatus suitable for performing such a method. In particular the present invention relates to a method for operating a printing apparatus, the printing apparatus comprising a page-wide curing array, the page wide curing array comprising a number of individually controllable units, wherein the individually controllable units are operable in at least two modes, the at least two modes being an Off mode and an On mode.

### BACKGROUND OF THE INVENTION

Methods for operating a printing apparatus using a radiation-curable ink are known in the art. Generally, such methods comprise the step of applying the radiation-curable ink onto a recording medium, e.g. by jetting droplets of the ink using an ink jet printer.

After the ink has been applied onto the recording medium, the ink is hardened by irradiating the ink using a curing unit configured to in operation emit a suitable source of radiation, such as UV radiation. The curing unit may be a page-wide curing array. An example of a printing apparatus comprising a page-wide curing array is disclosed in EP 3481640.

An alternative to a page-wide curing array is a scanning curing array. An example of a printing apparatus comprising a scanning curing is disclosed in EP 3038837. Using a page-wide array has a number of advantages compared to using a scanning curing unit. A page-wide array may irradiate the entire width of a recording medium, whereas a scanning curing unit irradiates on part of the width of the recording medium. Hence, a page-wide curing array may irradiate the ink applied onto the recording medium for a longer time, thereby providing a higher dose of radiation to the ink, which may result in improved curing. In addition, a scanning curing unit needs to be moved in reciprocation in a scanning direction. Appropriate driving means are needed, which increase costs and complexity of the printing apparatus. Further, the movement of the scanning curing unit may cause vibrations in the system.

Even though the page-wide curing array has advantages over the scanning curing unit, a page-wide curing unit as disclosed in EP 3481640 has limitations, as it is not possible to differentiate in timing and amount of radiation received along the width of the recording medium.

Therefore a need exists for operating a printing apparatus while mitigating the above mentioned problems.

It is therefore an object of the present invention to provide such a method.

It is another object of the present invention to provide an printing apparatus suitable for performing such a method.

### SUMMARY OF THE INVENTION

The object of the invention is achieved in a method for operating a printing apparatus, the printing apparatus comprising
at least one printing unit configured to in operation deposit a predetermined pattern of a radiation-curable fluid on a recording medium, the at least one printing unit comprises a scanning printing unit, the scanning printing unit being configured to in operation move in reciprocation in a first direction, the first direction being substantially perpendicular to a direction of relative recording medium transport;
a recording medium support unit for supporting a recording medium;
a page-wide curing array, the curing unit being configured to in operation irradiate a recording medium provided with a radiation-curable fluid, the page wide curing array extending in the first direction, the page wide curing array comprising a number of individually controllable units, the individually controllable units being adjacent to one another in the first direction, the individually controllable units being configured to in operation emit radiation onto an area of the recording medium, wherein the individually controllable units are operable in at least two modes, the at least two modes including an Off mode and an On mode;
the method comprising the steps of:
controlling the individually controllable units to be in one of the at least two modes wherein the method further comprises the steps of:
depositing a radiation-curable fluid onto a recording medium using the scanning printing unit,
wherein the individual units are controlled such that the time between deposition of the radiation-curable fluid and irradiation of the radiation-curable fluid is essentially the same for different areas of the recording medium.

The method may be performed using a printing apparatus. A printing apparatus is also referred to as printer. The printer may be configured to in printing operation apply a radiation-curable fluid. The radiation-curable fluid may be a radiation-curable inkjet ink, such as a UV-curable inkjet ink. Suitable types of radiation-curable inkjet inks including UV-curable inkjet inks are known in the art. Preferably, the printer may be an inkjet printer, configured to apply ink onto the recording medium by jetting droplets of ink onto the recording medium in a predetermined pattern to form an image.

The printing apparatus comprises a printing unit configured to in operation deposit a predetermined pattern of a radiation-curable fluid on a recording medium. The printing unit may be an inkjet print head configured to in operation jet ink onto the recording medium. The print head may be for example a thermal inkjet print head or a piezo electric inkjet print head. The printer may comprise a plurality of inkjet print heads. One type or color of ink may be used to form the image, but alternatively more than one type and/or color of ink may be used. A Cyan, a Magenta, a Yellow and a blacK ink may be used to form the image. In addition, one or more of a white ink, brown ink, grey ink, light magenta, light cyan, red, green, orange, purple ink may be used. Further, one or more of a primer composition, an overcoat composition and a metallic ink may be used.

The print unit may be arranged to move in reciprocation in the first direction. The print unit may comprise a scanning printing unit. The scanning print unit may be configured to in operation move in reciprocation in a first direction, the first direction being substantially perpendicular to a direction of relative recording medium transport. The scanning print unit may be positioned upstream with respect to the page-wide array in the media transport direction, the media transport direction being essentially perpendicular to the first direction. The scanning print unit may be arranged to move along a guide rail. Optionally, the scanning print unit may be mounted on a carriage. The print unit may eject radiation-curable fluid onto the recording medium during the scanning movement. The timing of application of the fluid on the recording medium may thus depend on the position in the scanning direction.

The printing apparatus may further comprise a medium support. The medium support may be configured to in operation support the recording medium. Optionally, the recording medium may be moved in a medium transport direction. The medium support may be a flat table. Optionally, the medium support may comprise an endless belt. The medium support may comprise holes for applying an underpressure. Applying an underpressure may fix the recording medium to the medium support.

Optionally, the printing apparatus may comprise medium transport unit. The medium transport unit may be configured to in operation move the recording medium relative to the printer in the medium transport direction.

The printing apparatus further comprises a page-wide curing array. The page-wide curing array is configured to in operation irradiate a recording medium provided with a radiation-curable fluid. By irradiating the radiation-curable fluid, a chemical reaction may occur in the radiation-curable fluid, which may result in curing or pre-curing of the fluid. The page-wide array may extend in a first direction, the first direction being substantially perpendicular to a direction of relative recording medium transport. The recording medium may move with respect to the printing unit. The relative movement may be effected by moving at least one of the recording medium and print unit. The direction of relative movement of the print unit and the recording medium is the relative recording medium transport direction. The first direction is substantially perpendicular to the relative recording medium transport direction. The page wide curing array comprising a number of individually controllable units. The radiation emitting units may be single radiation emitting units, such as lamps or LEDs. Alternatively, the radiation emitting units may comprise a plurality of lamps or LEDs or a combination thereof. Non-limiting examples of lamps are UV arc lamps, mercury vapor lamps and metal halide bulbs. Preferably, the radiation emitting units comprise at least one LED. The radiation emitting units are arranged along a direction perpendicular to a direction of medium transport. The length of the page-wide curing array in the direction perpendicular to the medium transport direction may be selected such that the entire width of a recording medium can be irradiated with radiation emitted by the page-wide array. For example, the length of the page-wide curing array in the direction perpendicular to the medium transport direction may be about the same as the maximum width of a recording medium that can be supported by the medium support. The radiation emitting unit may be configured to in operation irradiate a certain area of the recording medium. By controlling the individual radiation emitting units, the radiation received by a certain area of the recording medium during a certain period of time may be controlled.

The radiation emitting units may be individually controllable. The radiation emitting units may be controlled e.g. by controlling the amount of power supplied to the individual radiation emitting units. The individually controllable units are operable in at least two modes, the at least two modes including an Off mode and an On mode. The individual radiation emitting units may be controlled to be in one of the at least two modes. Preferably, each one of the individually controllable units is controlled to be in one of the at least two modes, wherein the mode of a first unit may be the same or different than the mode of a second unit. In the Off mode, the radiation emitting unit may not emit radiation. In case a radiation emitting unit is in the Off mode, and no radiation is emitted by that individual radiation emitting unit, that radiation emitting unit may not (locally) induce a polymerization reaction in the ink to pin or cure the ink. In the On mode, the radiation emitting unit may emit radiation. In case a radiation emitting unit is in the On mode, and radiation is emitted by that individual radiation emitting unit, that radiation emitting unit may (locally) induce a polymerization reaction in the ink to pin or cure the ink. Optionally, the radiation emitting may be operable in more than two modes. Preferably, at least one of the individually controllable units is in a first one of the at least two modes and at least one of the individually controllable units is in a second one of the at least two modes, the first one of the at last two modes being different from the second one of the at least two modes. The individually controllable radiation emitting units may be individually controlled and the plurality of individually controllable mode may each be operated independent from one another.

The page-wide array having a plurality of individually controllable units allows to differentiate in whether or not an image locally receives radiation.

The print unit may eject radiation-curable fluid onto the recording medium during the scanning movement. The scanning movement is a movement in the scanning direction. The timing of application of the fluid on the recording medium may thus depend on the position in the scanning direction.

When curing an image after applying the fluid on the recording medium, it is desired that the time interval between applying the fluid and curing the fluid is the same throughout the image. By keeping the difference in time interval throughout the image as small as possible, print artifacts, such as gloss banding may be reduced or even prevented. The time interval may be kept constant by suitably controlling the individual controllable radiation emitting units to irradiate an area of the recording medium at a predetermined time interval after the radiation-curable fluid has been applied onto that area. The radiation emitting units may irradiate the area of the recording medium in each one of the at least two modes, except in the Off mode. By controlling the individual controllable elements to be in an operating mode at a first point in time and in the Off mode at a second point in time, the radiation may mimic scanning movement of the scanning print unit and the time interval between applying the ink and curing the ink may be kept constant. By keeping the time interval between applying the ink and curing the ink constant, an image having improved image quality may be obtained. Artefacts, like gloss banding may be reduced.

The time interval between deposition of the radiation-curable fluid and irradiation of the radiation-curable fluid may be suitably selected. For example, the time interval may be less than 5 seconds, for example less than 1 second. A time interval of less than one second may prevent the ink droplets from spreading excessively, thereby preventing color bleed. Further, the gloss level of the image may be controlled to be low, yielding a matt image, by selecting the time interval to be less than 5 seconds. Alternatively, the time interval may be large, such as more than 10 seconds, for example more than 30 seconds. By selecting a larger time interval, such as a time interval of more than 10 seconds, the droplets may be allowed time to spread, thereby resulting in an image having a high gloss level. Intermediate time interval may be selected to obtain intermediate gloss levels.

In an embodiment, at a first point in time, a first unit is controlled to be in a mode not being the Off mode and a second unit is controlled to be in the Off mode, the position of the first unit in the first direction and the position of the second unit in the first direction being adjacent to one another, and at a second point in time, the first unit is controlled to be the Off mode and a second unit is controlled to be in in a mode not being the Off mode.

The modes at which the individual radiation emitting units are operated may change in time. In the method according to the embodiment, the radiation emitted may move in time along the first direction. This allows to control what area of the recording medium is irradiated at a certain point in time.

Optionally, the page wide array comprise a third unit. The position of the first unit in the first direction and the position of the second unit in the first direction being is adjacent to one another, and the position of the second unit in the first direction and the position of the third unit in the first direction being is adjacent to one another, the second unit being positioned in between the first unit and the third unit. At a first point in time, the first unit may be controlled to be in a mode not being the Off mode, the second unit and the third unit may controlled to be in the Off mode, at a second point in time, the first unit and the third unit are controlled to be the Off mode and a second unit is controlled to be in in a mode not being the Off mode and at a third point in time, the first unit and the second unit are controlled to be the Off mode and a third unit is controlled to be in in a mode not being the Off mode. Alternatively, at a first point in time, the first unit and the second unit may be controlled to be in a mode not being the Off mode, the third unit may controlled to be in the Off mode, at a second point in time, the second unit and the third unit are controlled to be in a mode not being the Off mode and the first unit is controlled to be in the Off mode.

In an embodiment, the at least two modes further include a Pin mode. In the Pin mode, the radiation emitting units may emit radiation having a reduced intensity, i.e. an intensity between 0 and the intensity of the On mode. By using the Pin mode, ink applied onto the recording medium may be pinned, i.e. partially cured. The page-wide array having a plurality of individually controllable units allows to differentiate in whether or not a image locally receives radiation and the amount of radiation received along the width of the recording medium.

The modes of the radiation emitting units may further include additional modes, such as, but not limited to a Flash mode and a Deep Cure mode. In the Flash mode, the radiation emitting units may emit radiation in a flashed way; i.e. during short periods radiation is emitted and in between these short periods no radiation may be emitted. In the Deep Cure mode, radiation may be emitted that is high in energy. For example, radiation having a higher intensity than the radiation emitted in the On mode may be emitted. An alternative example of such radiation is UV-c radiation. By applying the Deep Cure mode, the ink applied onto the recording medium may be fully cured, leaving no or hardly any unreacted monomers. The modes in which radiation is emitting, i.e. all modes except the Off mode may be referred to as operating modes.

In an embodiment, the page-wide curing array comprises a first set of individually controllable units and a second set of individually controllable units, wherein the first set of individually controllable units is configured to in operation emit a first type of radiation and a second set of individually controllable units is configured to in operation emit a second type of radiation. The first and second set may be operated simultaneously or alternatively, the first and second set may be operated at different timings.

Each set may comprise a plurality of individually controllable radiation emitting units. In operation at least one of the individually controllable units of one of the plurality of sets on individually controllable units may be in a mode not being the Off mode.

The first type of radiation may be IR radiation or UV radiation. The second type of radiation may be UV-radiation. The wavelength of the first type of radiation may be different from the wavelength of the second type of radiation. The wavelength of the first type of radiation may be shorter from the wavelength of the second type of radiation. Preferably, the wavelength of the first type of radiation may be in the range of 350-400 nm and the wavelength of the second type of radiation may be in the range of 380-420 nm.

In an embodiment, the printing apparatus further comprises an optical element, the optical element being configured to in operation receive radiation from at least one of the individually controllable units of the page wide curing array and to deflect the radiation towards the recording medium.

Using an optical element may allow more freedom with respect to position the page-wide array and the printing unit in the printing apparatus. In addition, the optical element may allow to adjust the location and/or size of the area of the recording medium that receives the radiation. Examples of optical elements include, but are not limited to, one or more mirrors, one or more lenses, one or more optical fibres, or combinations thereof.

In a further embodiment, in printing operation the scanning printing unit is in a position x along the first direction, and an individually controllable unit located in position x along the first direction being in the Off mode and at least one of the individually controllable units not being located in position x along the first direction being in a mode other than the Off mode.

In this embodiment, no radiation may be emitted near the scanning printing unit, but radiation may be emitted more remote form the scanning printing unit. Radiation may cure radiation-curable ink. This is usually a wanted phenomenon once the ink has been applied onto the recording medium, but may be unwanted if the radiation-curable ink is being ejected by the printing unit. Curing the ink while it is being jetted may result in unwanted phenomena, such as nozzle clogging and pollution of a nozzle plate. Both of these phenomena may hamper proper future ejection of ink.

In a further embodiment, all individually controllable units not being located in position x along the first direction being in a mode other than the Off mode.

The individually controllable units being in a mode other than the Off mode may emit radiation. By controlling all individually controllable units not being located in position x along the first direction to be in a mode other than the Off mode, a high doses of radiation may be provided to the radiation-curable ink provided on the recording medium to properly cure the ink. Further, no unwanted phenomena may be induced in or around the printing unit.

In an embodiment, the doses of radiation received by the radiation-curable fluid is controlled by controlling the individually controllable radiation-emitting units. The doses received by the radiation-curable fluid is determined by the amount of time the fluid receives radiation and the intensity of the radiation. The doses of radiation can be controlled by controlling the mode of the individually controllable units. The more units are in a mode other than the Off mode, the more radiation is received by the fluid. Further, by controlling the mode of the units not being in the Off mode, the amount of radiation emitted per radiation-emitting unit per time unit can be determined. For example, in the Pin mode the amount of radiation emitted per radiation-emitting unit per time unit may be less than in the On mode. By suitably controlling the doses of radiation received by the radiation-curable fluid, the curing of the radiation-curable fluid can be suitably controlled.

In an aspect of the invention, a printing apparatus is provided, the printing apparatus comprising:
at least one printing unit configured to in operation deposit a predetermined pattern of a radiation-curable fluid on a recording medium, the at least one printing unit comprises a scanning printing unit, the scanning printing unit being configured to in operation move in reciprocation in a first direction, the first direction being substantially perpendicular to a direction of relative recording medium transport;
a page-wide curing array, the curing unit being configured to in operation irradiate a recording medium provided with a radiation-curable fluid, the page wide curing array extending in the first direction, the page wide curing array comprising a number of individually controllable units, the individually controllable units being arranged along the first direction, the individually controllable units being configured to in operation emit radiation onto an area of the recording medium, wherein the individually controllable units are operable in at least two modes, the at least two modes including an Off mode and an On mode;
a recording medium support for supporting a recording medium;
a control unit configured to in operation control the printing apparatus to perform a method according to the present invention.

The printing apparatus is thus configured to perform the method according to the present invention.

In an embodiment, the printing apparatus further comprises an optical element, the optical element being configured to in operation receive radiation from at least one of the individually controllable units of the page wide curing array and to deflect the radiation towards the recording medium. This printing apparatus is configured to perform the method according to an embodiment of the invention.

In a further aspect of the invention, a software product is provided, the software product comprising program code on a non-transitory machine-readable medium, wherein the program code, when loaded into a controller of a printing apparatus with at least one printing unit for depositing a radiation-curable fluid, a page-wide curing array and a control unit, causes the controller to perform a method according to the present invention.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view of a first example of a printing system according to the present invention in a first printing mode;

FIG. 2 is a schematic perspective view of a second example of a printing system according to the present invention in a second printing mode;

FIG. 3 is a schematic diagram of a control unit of a reprographic system according to FIG. 1 or 2;

FIG. 4A is a schematic view of a page-wide curing array according to a first example of the present invention.

FIG. 4B is a schematic view of a page-wide curing array according to a second example of the present invention.

FIG. 5A is a schematic view of a page-wide curing array according to a third example of the present invention.

FIG. 5B is a schematic view of a page-wide curing array according to a fourth example of the present invention.

FIG. 6A-6H schematically show the operation of a page-wide curing array according to a fifth example of the invention.

FIG. 7A-7C schematically show the operation of a page-wide curing array according to a sixth example of the invention.

FIG. 8A-8D schematically show the operation of a page-wide curing array according to a seventh example of the invention.

In the drawings, same reference numerals refer to same elements.

### DETAILED DESCRIPTION OF THE PREFERRED EMBODIMENTS

The present invention will now be described with reference to the accompanying drawings, wherein the same reference numerals have been used to identify the same or similar elements throughout the several views.

### Printing System

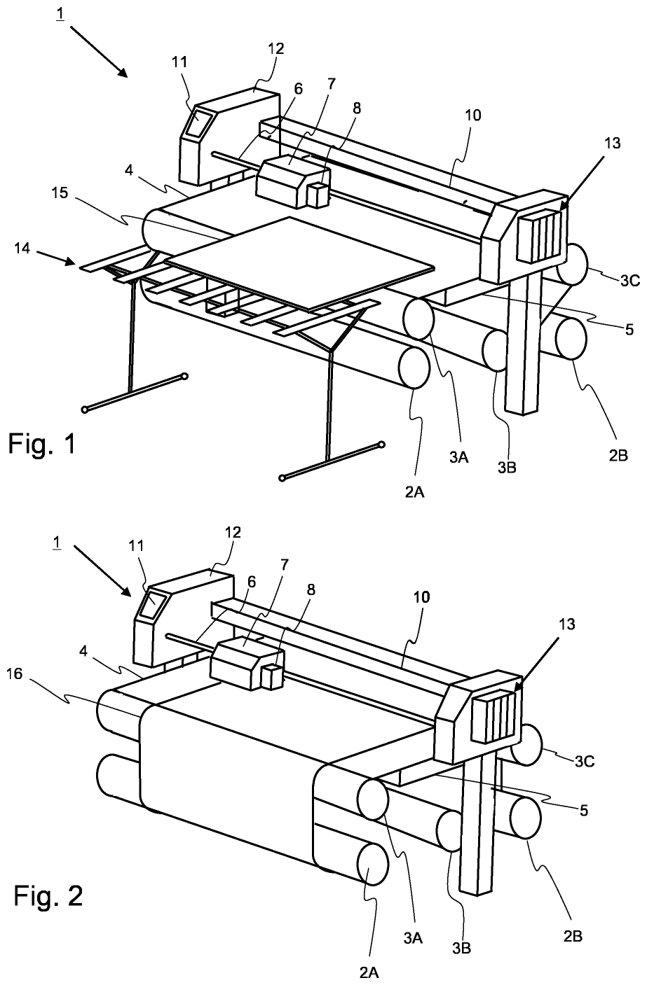

FIG. 1 shows a printing apparatus. A printing apparatus is also known as printer. The printing apparatus 1 comprises an scanning printing unit 7 for printing on a recording medium 15. The recording medium 15 in FIG. 1 is a relatively rigid substrate, such as a panel. The recording medium 15 is supplied from a media input unit 14, which may be configured for storing a plurality of such print media 15 and supplying these to the printer 1. The printer 1 comprises a medium support 4. Printer 1 may further comprise transport means for receiving and transporting the recording medium 15 along the scanning printing unit 7. In FIG. 1, the medium support is embodied as an endless belt 4. The endless belt is an endless transport belt 4 supported on a plurality of support rollers 3A, 3B, 3C. At least one of the support rollers 3A, 3B, 3C is provided with driving means for moving the belt 4. The belt 4 is therefore configured to support and transport the recording medium. Additionally, one or more one of the support rollers 3A, 3B, 3C may be configured to be moved and/or tilted to adjust and control the lateral position of the belt 4. The scanning printing unit 7 may be provided with a sensor 8, such as a CCD camera, to determine the relative position of belt 4 and/or the recording medium 15. Data from said sensor 8 may be applied to control the position of the belt 4 and/or the recording medium 15. The belt 4 is further provided with through-holes and a suction box 5 in connection with a suction source (not shown), such that an underpressure may be applied to the recording medium 15 via the through-holes in the belt 4. The underpressure adheres the recording medium 15 flatly to the belt 4 and prevents displacement of the recording medium 15 with respect to the belt 4. Due to this holding the belt 4 is able to transport the recording medium 15. It will be appreciated that other suitable transport means, such as rollers, steppers, etc, may alternatively be applied. The recording medium 15 may be transported stepwise and/or in continuous movement.

The scanning printing unit 7 is configured to translate along a first guide beam 6 in a scanning direction. The scanning direction is perpendicular to the direction in which the print medium is transported by the belt 4. The scanning printing unit 7 holds a plurality of print heads (not shown), which are configured to jet a plurality of different marking materials (different colors of ink, primers, coatings, etc.) on the recording medium 15. Each marking material for use in the scanning printing unit 7 is stored in one of a plurality of containers arranged in fluid connection with the respective print heads for supplying marking material to said print heads to print an image on the recording medium 15.

The application of the marking material, such as the radiation-curable ink from the printing units is performed in accordance with data provided in the respective print job. The printing unit may comprise one or more inkjet print heads. The timing by which the droplets of marking material are released from the one or more print heads determines their position on the recording medium 15. The timing may be adjusted based on the position of the scanning printing unit 7 along the first guide beam 6. The above mentioned sensor 8 may therein be applied to determine the relative position and/or velocity of the scanning printing unit 7 with respect to the recording medium 15. Based upon data from the sensor 8, the release timing of the marking material may be adjusted. Upon ejection of the marking material, some marking material may be spilled and stay on a nozzle surface of the print heads. The marking material present on the nozzle surface, may negatively influence the ejection of droplets and the placement of these droplets on the recording medium 15. Therefore, it may be advantageous to remove excess of marking material from the nozzle surface. The excess of marking material may be removed for example by wiping with a wiper and/or by application of a suitable anti-wetting property of the surface, e.g. provided by a coating.

The marking materials may require treatment to properly fixate them on the print medium. Thereto, a fixation unit is provided downstream of the scanning printing unit 7. The fixation unit may emit radiation to facilitate the marking material fixation process. In the example of FIG. 1, the fixation unit is page-wide curing array 10. The page-wide curing array 10 extends in the main scanning direction. The page-wide curing array does not move in operation in the main scanning direction. The page-wide array may move in the direction of medium transport, which is a direction perpendicular to the scanning direction.

The page-wide curing array 10 is configured to in operation emit radiation of certain frequencies, which interacts with the marking materials, for example UV light in case of UV-curable inks. Optionally (not shown), the scanning printing unit 7 may be provided with a further fixation unit on the same carriage which holds the print heads. This further fixation unit can be used to (partially) cure and/or harden the marking materials, independent of or interaction with the page-wide curing array 10.

After printing and fixation, the recording medium 15 is transported to a receiving unit (not shown). The receiving unit may comprise a take-up roller for winding up the recording medium 15, a receiving tray for supporting sheets of recording medium 15, or a rigid media handler, similar to the media input unit 14. Optionally, the receiving unit may comprise processing means for processing the medium 8, 9 after printing, e.g. a post-treatment device such as a coater, a folder, a cutter, or a puncher.

Printing apparatus 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the recording medium 15. Such rigid print media 15 may be panels, for example panels for doors or walls, corrugated media, plates formed of plastic or metal, etc. To handle these rigid print media 15, the printer 1 in FIG. 1 is configured with a substantially linear transport path: from the media input device 14, the recording medium 15 moves forward along the scanning printing unit 7 at a at substantially constant height. The media input unit 14 and the receiving unit are positioned at the level of the medium support surface of the belt 4.

In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Control

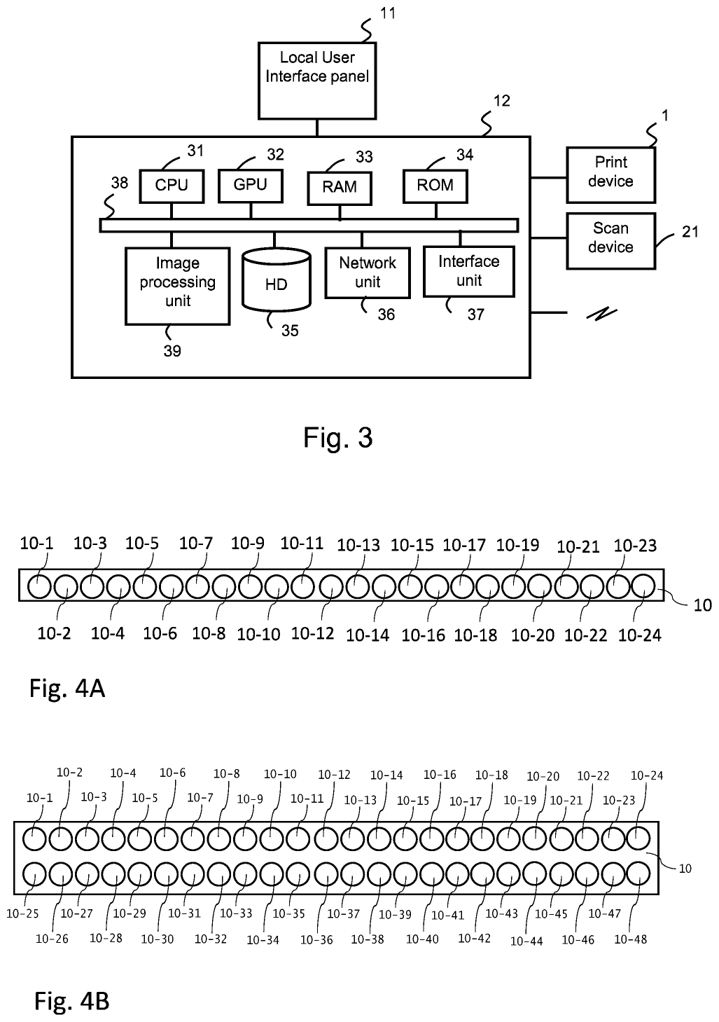

An embodiment of the control unit 12 is in more detail presented in FIG. 3. As shown in FIG. 3, the control unit 12 comprises a Central Processing Unit (CPU) 31, a Graphical Processor Unit (GPU) 32, a Random Access Memory (RAM) 33, a Read Only Memory (ROM) 34, a network unit 36, an interface unit 37, a hard disk (HD) 35 and an image processing unit 39 such as a Raster Image Processor (RIP). The aforementioned units 31-37 are interconnected through a bus system 38. However, the control unit 12 may also be a distributed control unit.

The CPU 31 controls the printing system 1 in accordance with control programs stored in the ROM 34 or on the HD 35 and the local user interface panel 5. The CPU 31 also controls the image processing unit 39 and the GPU 32. The ROM 34 stores programs and data such as boot program, set-up program, various set-up data or the like, which are to be read out and executed by the CPU 31. The hard disk 35 is an example of a non-volatile storage unit for storing and saving programs and data which make the CPU 31 execute a print process to be described later. The hard disk 35 also comprises an area for saving the data of externally submitted print jobs. The programs and data on the HD 35 are read out onto the RAM 33 by the CPU 31 as needed. The RAM 33 has an area for temporarily storing the programs and data read out from the ROM 34 and HD 35 by the CPU 31, and a work area which is used by the CPU 31 to execute various processes. The interface unit 37 connects the control unit 12 to the client devices, such as scan device 21 and to the printing system 1. The network unit 36 connects the control unit 12 to the network N and is designed to provide communication with the workstations (not shown) and with other devices 21 reachable via the network N. The image processing unit 39 may be implemented as a software component running on an operation system of the control unit 12 or as a firmware program, for example embodied in a field-programmable gate array (FPGA) or an application-specific integrated circuit (ASIC). The image processing unit 39 has functions for reading, interpreting and rasterizing the print job data. Said print job data contains image data to be printed (i.e. fonts and graphics that describe the content of the document to be printed, described in a Page Description Language or the like), image processing attributes and print settings.

FIG. 4A is a schematic view of a page-wide curing array 10 according to a first example of the present invention. The page-wide curing array 10 comprises a plurality of LED elements 10-1, 10-2, 10-3, . . . , 10-24. The LED elements 10-1, 10-2, 10-3, . . . , 10-24 according to the example shown in FIG. 4A are positioned in a single row. However, in an alternative example, the radiation emitting units could be arranged differently, for example randomly or in a plurality of rows. The LED elements 10-1, 10-2, 10-3, . . . 10-24 are individually controllable. Each of the individual LED elements 10-1, 10-2, 10-3, . . . , 10-24 can be switched on or off independently form the other LED elements 10-1, 10-2, 10-3, . . . , 10-24. The radiation emitting units are embodied as LED elements in the first example. In an alternative example, a different radiation emitting units can be used.

FIG. 4B is a schematic view of a page-wide curing array according to a second example of the present invention. The page-wide curing array 10 comprises a plurality of LED elements 10-1, 10-2, 10-3, . . . , 10-48. The LED elements 10-1, 10-2, 10-3, . . . , 10-48 according to the example shown in FIG. 4B are positioned in two rows. In a first row, the LED elements 10-1 to 10-24 are positioned and in a second row, LED elements 10-25 to 10-48 are positioned. Each of the individual LED elements 10-1, 10-2, 10-3, . . . , 10-48 can be switched on or off independently form the other LED elements 10-1, 10-2, 10-3, . . . , 10-48. Each LED element may be the same or different LED elements may be used within the page-wide curing array, for example, LED elements having a different intensity and/or emitting a different wavelength. For example, the LED elements 10-1-10-24 of the first row may emit radiation having a first wavelength, whereas the LED elements 10-25-10-48 of the second row may emit radiation having a second wavelength.

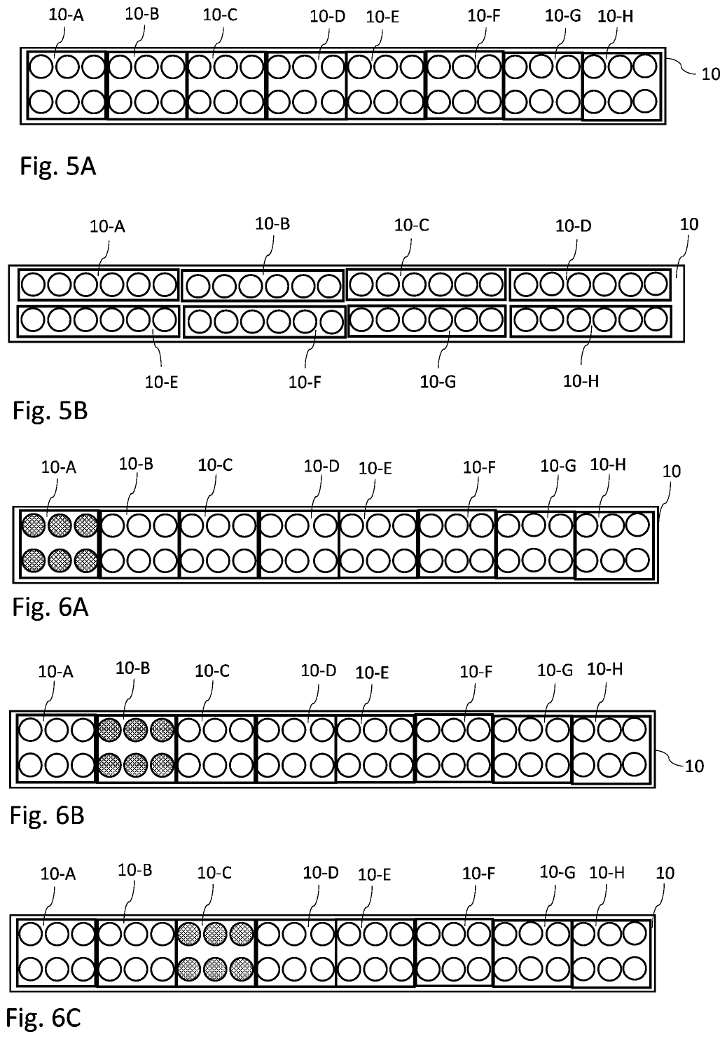

FIG. 5A is a schematic view of a page-wide curing array according to a third example of the present invention.

The page-wide curing array 10 comprises a plurality of units 10-A, 10-B, . . . , 10-H. Each unit is formed by 6 LED emitting elements. However, in an alternative example, units could comprise a different number of radiation emitting units. The number of radiation emitting units may be the same or different for the plurality of units within the page-wide curing array.

Each one of the units 10-A, 10-B, . . . , 10-H can be switched on or off independently from the other units 10-A, 10-B, . . . , 10-H. The units in this example are embodied of units comprising three times two LED elements, but in an alternative example, a different configuration can be used.

FIG. 5B is a schematic view of a page-wide curing array according to a fourth example of the present invention. The page-wide curing array 10 comprises a plurality of units 10-A, 10-B, . . . , 10-H. Each unit is formed by 6 LED emitting elements.

Each one of the units 10-A, 10-B, . . . , 10-H can be switched on or off independently from the other units 10-A, 10-B, . . . , 10-H. The units in this example are embodied of units comprising six LED elements, positioned in a row.

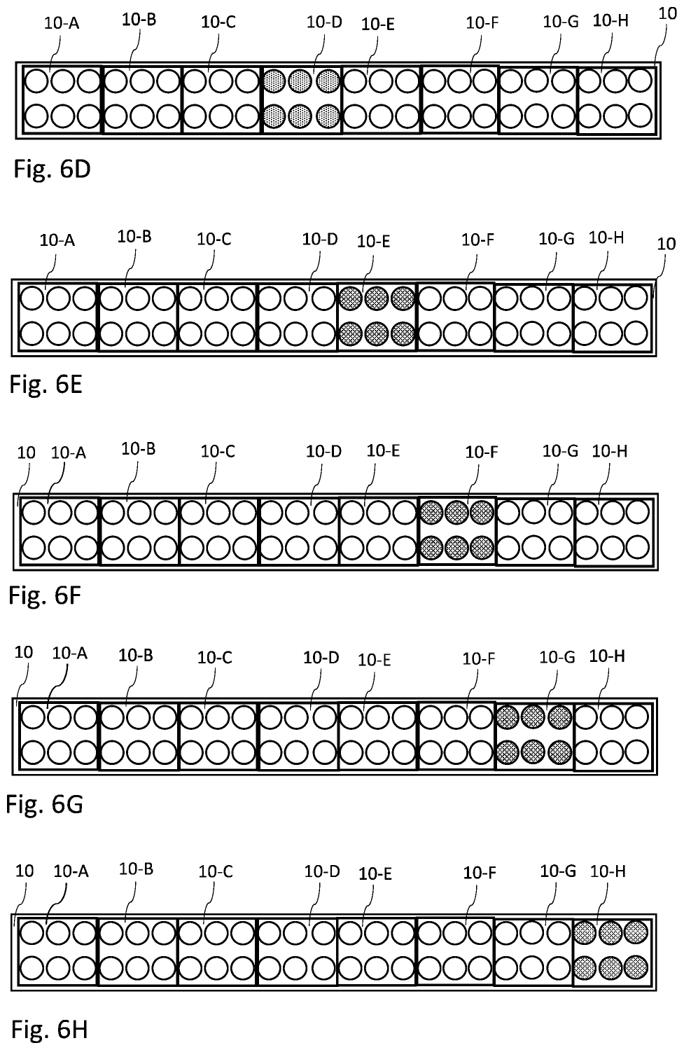

FIG. 6A-6H schematically show the operation of a page-wide curing array according to an example of the invention.

FIG. 6A-6H show a page-wide curing array 10 comprising eight individually controllable units 10-A-10-H. In FIG. 6A, the first unit, i.e. unit 10-A, is in a first mode, whereas the other units 10-B-10-H are in second mode.

In FIG. 6B, the second unit, i.e. unit 10-B, is in the first mode, whereas the other units 10-A and 10-C-10-H are in the second mode. In FIG. 6C, the third unit, i.e. unit 10-C, is in the first mode, whereas the other units 10-A, 10-B and 10-D-10-H are in the second mode. In FIG. 6D, the fourth unit, i.e. unit 10-D, is in the first mode, whereas the other units 10-A-10-C and 10-E-10-H are in the second mode. In FIG. 6E, the fifth unit, i.e. unit 10-E, is in the first mode, whereas the other units 10-A-10-D and 10-F-10-H are in the second mode. In FIG. 6F, the sixth unit, i.e. unit 10-F, is in the first mode, whereas the other units 10-A-10-E, 10-G and 10-H are in the second mode. In FIG. 6G, the seventh unit, i.e. unit 10-G, is in the first mode, whereas the other units 10-A-10-F and 10-H are in the second mode. In FIG. 6H, the eighth unit, i.e. unit 10-H, is in the first mode, whereas the other units 10-A-10-G are in the second mode. Preferably, the first mode is the On mode and the second mode is the Off mode.

In an alternative embodiment (not shown), the first mode may be the Pin mode, whereas the second mode is the Off mode. In a further alternative embodiment, the first mode may be the On mode, whereas the second mode is the Pin mode.

By changing the modes in which the units are operated as shown in the FIG. 6A-6H, the radiation is first emitted at a first side of the page-wide array and gradually emitted further away from the first side edge and closer to a second side edge. Finally, it is emitted at the second side edge of the page-wide array. When the page-wide array is positioned in a printing apparatus, a first side of the recording medium maybe irradiated first and the radiation may move gradually form the first side of the recording medium to the second side of the recording medium. This way, different sections of the recording medium can be irradiated at a different point in time.

When used in combination with a scanning print unit, this can be used e.g. to make sure the time interval between jetting of the ink and irradiating the ink is the same for the different sections of the recording medium. When used in combination with one or more optical elements, such as mirrors or lenses, this can be used to selectively irradiate radiations towards said one or more optical elements.

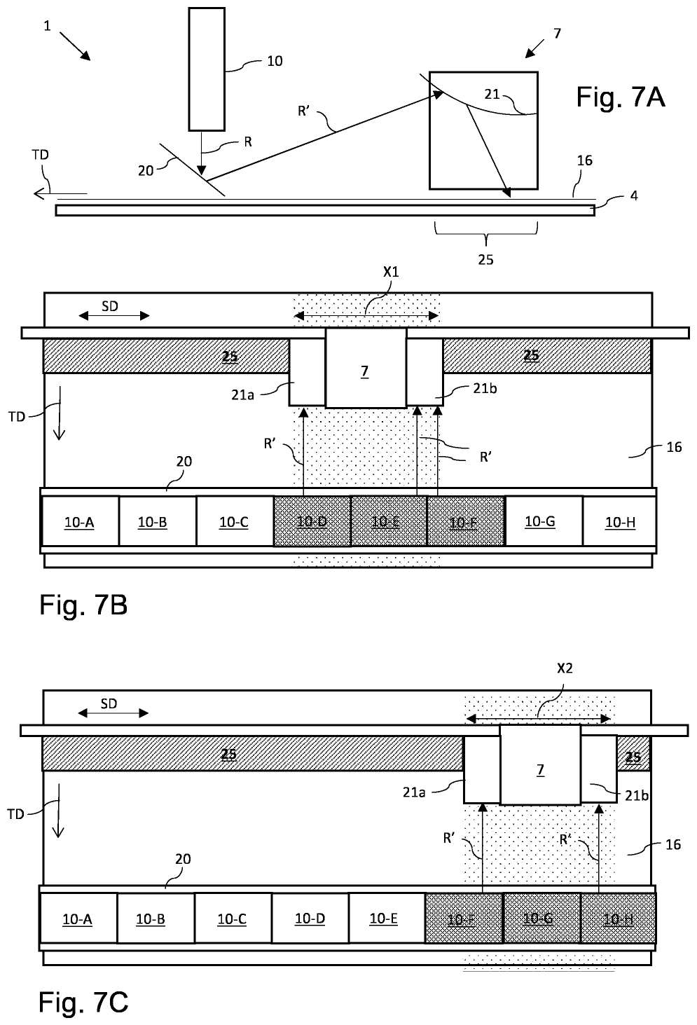

FIG. 7A shows a schematic perspective view of a printing apparatus 1. The printing apparatus 1 comprises a scanning print unit 7, a page-wide curing array 10 and a recording medium support 4 that support a recording medium 16. The printing apparatus 1 further comprises a first mirror element 20. The scanning print unit 7 further comprises a second mirror element 21. The first mirror element 20 is configured to in operation receive radiation emitted by the curing array 10 and to reflect this radiation to the second mirror element 21. The second mirror 21 element may reflect the radiation towards an area of the recording medium. In the example shown in FIG. 7A, this area of the recording medium is part of a present swath 25. The second mirror element 21 comprises two mirror surfaces 21a, 21b as is shown in FIG. 7B and FIG. 7C. The width of the mirror surfaces 21a, 21b in the scanning direction is smaller than the width of the page-wide curing array 10 in the scanning direction SD. In printing operation, the scanning print unit 7 moves in reciprocation in the scanning direction. At a certain point in time, the scanning print unit 7 is at a certain position X. The position X changes with time, as the scanning print unit 7 moves in the scanning direction.

In FIG. 7B, the scanning print unit and the mirror surfaces 21a, 21b of the second mirror element are at a first position X1 along the scanning direction. The page-wide curing array has eight individually controllable units 10A-10-H. The individually controllable units 10-D, 10-E and 10-F are controlled to be in the On mode and emit radiation that is reflected by the first mirror element 20 to the second mirror element 21. The other individually controllable units, 10-A, 10-B, 10-C, 10-G and 10-H are controlled to be in the Off mode and do not emit radiation. If they would emit radiation, then this radiation would not reach the second mirror element 21. This radiation would hence not irradiate the ink deposited by the print head in the present swath 25. Therefore, the individually controllable units, 10-A, 10-B, 10-C, 10-G and 10-H are controlled to be in the Off mode.

In FIG. 7C, the scanning print unit and the mirror surfaces 21a, 21b of the second mirror element are at a position X2 along the scanning direction. Position X2 is different from position X1, shown in FIG. 7B. The individually controllable units 10-F-10-H are controlled to be in the On mode and emit radiation that is reflected by the first mirror element 20 to the second mirror element 21. The other individually controllable units, 10-A-10-E are controlled to be in the Off mode and do not emit radiation. If they would emit radiation, then this radiation would not reach the second mirror element 21. This radiation would hence not irradiate the ink deposited by the print unit 7 in the present swath 25. Therefore, the individually controllable units 10-A-10-E are controlled to be in the Off mode. By selectively switching individually controllable units Of and On, the ink deposited on the recording medium 16 can be suitably irradiated to cure the ink, without wasting energy by emitting radiation that may not contribute to curing the ink at the desired position on the recording medium.

The time interval between depositing ink and irradiating the ink deposited onto the recording medium is constant. Hence, the ink is allowed a time to spread over the recording medium and this time is constant for the entire image. This is beneficial for the print quality.

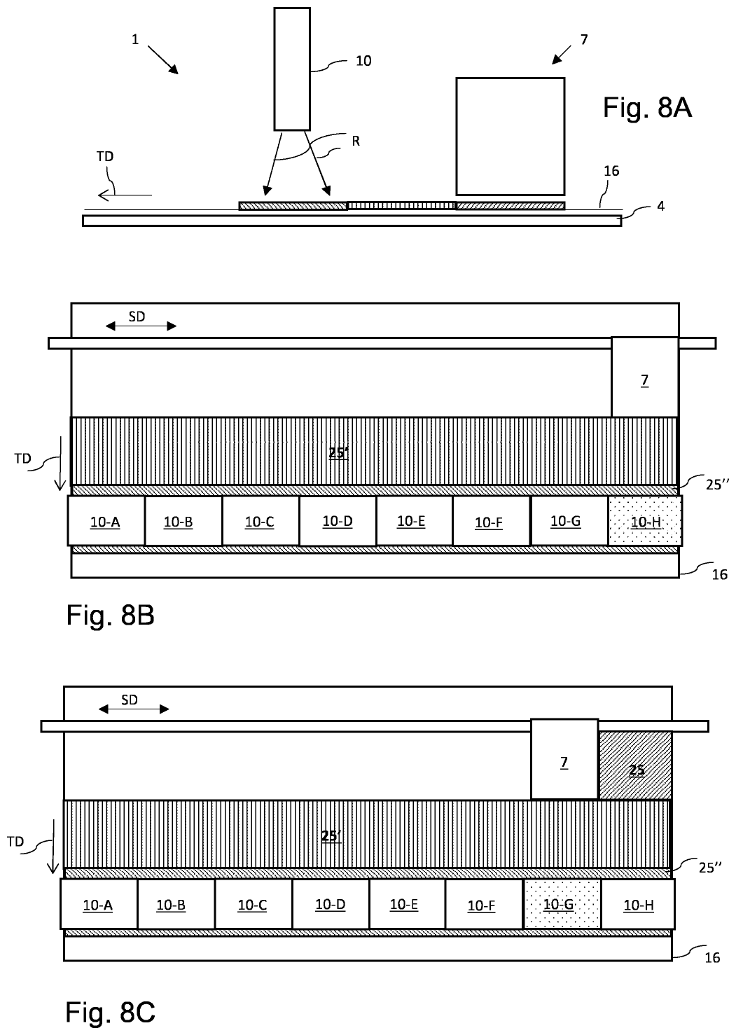

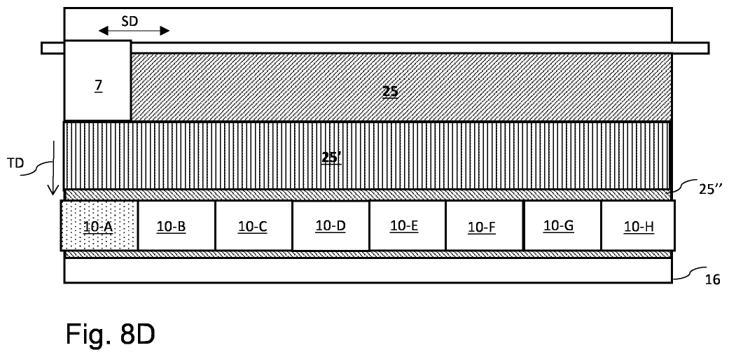

FIG. 8A shows a schematic perspective view of a printing apparatus 1. The printing apparatus 1 comprises a scanning print unit 7, a page-wide curing array 10 and a recording medium support 4 that support a recording medium 16. In printing operation, the scanning print unit 7 moves in reciprocation in the scanning direction SD and deposits ink onto the recording medium 16. The scanning print unit 7 moves from one side of the recording medium 16 to the other side. After such movement, the recording medium 16 may move with respect to the scanning print unit 7 and the page-wide curing array 10 in the transport direction TD. In an alternative embodiment, the scanning print unit 7 may move from one side of the recording medium 16 to the other side of the recording medium 16 a plurality of times before the recording medium 16 moves relative to the scanning print unit 7 and the page-wide curing array 10. The swath 25 is being formed in the example shown in FIG. 8A-8D, swath 25′ was formed before swath 25 was formed and swath 25″ was formed before swath 25′ was formed. Swath 25″ receives radiation emitted by the page-wide curing array 10 in the example shown in FIG. 8A-8D. In FIG. 8B-8D, a schematic top view is shown at three different moments during the formation of swath 25.

In the situation shown in FIG. 8B, the scanning print unit 7 just started depositing ink on the recording medium 16 to form swath 25. The radiation emitting unit 10-H is in the On mode and emits radiation R towards the recording medium. The other radiation emitting unit 10-A-10-G are in the Off mode and do not emit radiation. The radiation R emitted by radiation emitting unit 10-H irradiates the swath 25″. The position of the recording medium that receives radiation is two paper steps away (i.e. two movements in the transport direction) from the part of the recording medium onto which ink is deposited.

In the situation shown in FIG. 8C, the scanning print unit 7 advanced to the left, in the scanning direction with respect to the situation shown in FIG. 8B. The radiation emitting unit 10-G is in the On mode and emits radiation R towards the recording medium. The other radiation emitting unit 10-A-10-F and 10-H are in the Off mode and do not emit radiation. The radiation R emitted by radiation emitting unit 10-G irradiates the swath 25″. The position of the recording medium that receives radiation is two paper steps away (i.e. two movements in the transport direction) from the part of the recording medium onto which ink is deposited.

In the situation shown in In the situation shown in FIG. 8D, the scanning print unit 7 advanced more to the left, in the scanning direction SD with respect to the situation shown in FIG. 8C. The radiation emitting unit 10-A is in the On mode and emits radiation R towards the recording medium 16. The other radiation emitting unit 10-B-10-H are in the Off mode and do not emit radiation. The radiation R emitted by radiation emitting unit 10-A irradiates the swath 25″. The position of the recording medium that receives radiation is two paper steps away (i.e. two movements in the transport direction) from the part of the recording medium onto which ink is deposited.

In this way, the time interval between depositing ink and irradiating the ink deposited onto the recording medium is constant. Hence, the ink is allowed a time to spread over the recording medium and this time is constant for the entire image. This is beneficial for the print quality.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. A method for operating a printing apparatus, the printing apparatus comprising:
at least one printing unit configured to, in operation, deposit a predetermined pattern of a radiation-curable fluid on a recording medium, the at least one printing unit comprising a scanning printing unit, the scanning printing unit being configured to, in operation, move in reciprocation in a first direction, the first direction being substantially perpendicular to a direction of relative recording medium transport;
a recording medium support for supporting the recording medium; and
a page-wide curing array, the page-wide curing array being configured to, in operation, irradiate a recording medium provided with the radiation-curable fluid, the page-wide curing array extending in the first direction, the page-wide curing array comprising a number of individually controllable units, the individually controllable units being arranged along the first direction, the individually controllable units being configured to, in operation, emit radiation onto an area of the recording medium, wherein the individually controllable units are operable in at least two modes, the at least two modes including an Off mode and an On mode,
wherein the method comprises the steps of:
controlling the individually controllable units to be in one of the at least two modes; and
depositing the radiation-curable fluid onto a recording medium using the scanning printing unit,
wherein the individual units are controlled such that a time between deposition of the radiation-curable fluid and irradiation of the radiation-curable fluid is essentially the same for different areas of the recording medium.

2. The method according to claim 1, wherein, at a first point in time, a first unit is controlled to be in a mode not being the Off mode and a second unit is controlled to be in the Off mode, the position of the first unit in the first direction and the position of the second unit in the first direction being adjacent to one another, and at a second point in time, the first unit is controlled to be in the Off mode and the second unit is controlled to be in in a mode not being the Off mode.

3. The method according to claim 1, wherein the at least two modes further include a Pin mode.

4. The method according to claim 1, wherein the page-wide curing array comprises a first set of individually controllable units and a second set of individually controllable units, wherein the first set of individually controllable units is configured to, in operation, emit a first type of radiation and a second set of individually controllable units is configured to, in operation, emit a second type of radiation.

5. The method according to claim 1, wherein the printing apparatus further comprises an optical element, the optical element being configured to, in operation, receive radiation from at least one of the individually controllable units of the page wide curing array and to deflect the radiation towards the recording medium.

6. The method according to claim 1, wherein, in a printing operation, the scanning printing unit is in a position x along the first direction, and an individually controllable unit located in the position x along the first direction is in the Off mode and at least one of the individually controllable units not being located in the position x along the first direction is in a mode other than the Off mode.

7. The method according to claim 6, wherein all individually controllable units not being located in the position x along the first direction is in a mode other than the Off mode.

8. A printing apparatus comprising:
at least one printing unit configured to, in operation, deposit a predetermined pattern of a radiation-curable fluid on a recording medium, the at least one printing unit comprising a scanning printing unit, the scanning printing unit being configured to, in operation, move in reciprocation in a first direction, the first direction being substantially perpendicular to a direction of relative recording medium transport;
a page-wide curing array, the page-wide curing array being configured to, in operation, irradiate a recording medium provided with a radiation-curable fluid, the page-wide curing array extending in the first direction, the page-wide curing array comprising a number of individually controllable units, the individually controllable units being arranged along the first direction, the individually controllable units being configured to, in operation, emit radiation onto an area of the recording medium, wherein the individually controllable units are operable in at least two modes, the at least two modes including an Off mode and an On mode;
a recording medium support for supporting the recording medium; and
a control unit configured to, in operation, control the printing apparatus to perform the method according to claim 1.

9. The printing apparatus according to claim 8, wherein the printing apparatus further comprises an optical element, the optical element being configured to, in operation, receive radiation from at least one of the individually controllable units of the page wide curing array and to deflect the radiation towards the recording medium.

10. A software product comprising program code on a non-transitory machine-readable medium, wherein the program code, when loaded into a controller of a printing apparatus with the at least one printing unit for depositing the radiation-curable fluid, the page-wide curing array and a control unit, causes the controller to perform the method according to claim 1.
